(19) United States
(12) Patent Application Publication
(10) Pub. No.: US 2009/0021476 A1
(43) Pub. Date: Jan. 22, 2009

(54) INTEGRATED MEDICAL DISPLAY SYSTEM

(76) Inventors: Wolfgang Steinle, Munich (DE); Nils Frielinghaus, Heimstetten (DE); Christoffer Hamilton, Munich (DE)

Correspondence Address: DON W. BULSON (BRAI), RENNER, OTTO, BOISSELLE & SKLAR, LLP, 1621 EUCLID AVENUE - 19TH FLOOR, CLEVELAND, OH, 44115, US

(21) Appl. No.: 12/176,107

(22) Filed: Jul. 18, 2008

Related U.S. Application Data
(60) Provisional application No. 60/957,311, filed on Aug. 22, 2007.
(60) Provisional application No. 61/027,659, filed on Feb. 11, 2008.

(30) Foreign Application Priority Data
Jul. 20, 2007 (EP) 07 014 276
Feb. 4, 2008 (EP) 08 151 038

(51) Int. Cl. G09G 5/00

(52) U.S. Cl. 345/156

(57) ABSTRACT

The invention relates to a medical display system for performing a medical function, including: an image display unit configured for displaying a medical image data set, and an additional device, wherein the additional device is integrated with said image display unit and is configured to assist in performing the medical function of the medical display system.

### RELATED APPLICATION DATA

This application claims priority of U.S. Provisional Application Nos. 60/957,311 filed on Aug. 22, 2007 and 61/027,659 filed on Feb. 11, 2008, and European Application Nos. EP 07 014 276 filed on Jul. 20, 2007 and EP 08 151 038 filed on Feb. 4, 2008, which are incorporated herein by reference in their entirety.

### FIELD OF THE INVENTION

The invention relates generally to display of medical images and, more particularly, to an integrated medical display system that includes an image display unit adapted for displaying image data of medical origin and at least one other device integrated with the image display unit.

### BACKGROUND OF THE INVENTION

Medical image data may be produced two-dimensionally or three-dimensionally using several medical imaging methods (for example, computer tomography, magnetic resonance tomography, or x-ray). The resulting image data is increasingly stored as digital image data or digital image data sets. Some systems used for storing this image data bear the English designation Picture Archiving and Communication Systems (“PACS”). Primary viewing and/or evaluation of such digital image data often is limited to radiologists working in dedicated viewing rooms that have high-resolution, high-luminance monitors.

Outside of radiology, the transition from traditional film image viewing to digital image viewing is proceeding more slowly. Images that are viewed digitally in radiology may be reproduced onto film for secondary use access by other departments within a hospital, for example. This resulting dichotomy may be attributed to two reasons: (1) the fact that PACS computer programs are highly adapted to radiologists and (2) the PACS computer programs are often difficult to operate. Additionally, many physicians are accustomed to working with a film viewer that is illuminated from behind, also known as a “light box.”

Efforts to make digital image data more accessible for secondary use outside of radiology include using large-screen monitors in operating theaters, wherein, for example, the monitors can be operated using wireless keyboards or mice. Also used are simple touch screen devices as well as separate dedicated cameras for recognizing control inputs from physicians or operating staff.

US 2002/0039084 A1 discloses a display system for medical images that is constructed as a film viewer or light box.

In recent years operating theaters have been increasingly equipped with technical apparatus to provide the treating physicians with greater technical assistance. This “mechanization” of operating theaters often requires a great deal of space as well as increased training for the treatment staff so they can operate the many different devices.

### SUMMARY OF THE INVENTION

In accordance with the invention, an exemplary medical display system includes an image display unit (for example, a medical light box or a digital light box or “digital film viewer”). The system also includes at least one additional device that is integrated with the image display unit and assists in the dedicated medical functioning of the image display unit. In other words, the system in accordance with the invention integrally combines the image display unit with another device that may be used in the operating theater or otherwise may be used by the treatment staff. The additional device can supplement, enable, or restore functions of the image display device. Because such image display units are increasingly available in operating theaters, they are well-suited as a base element for such an integration

In accordance with the invention, it is possible to provide an adaptor on the image display unit that serves to attach the additional device and/or for an exchange of data between a data processing unit of the image display unit and the additional device. Many devices used in operating theaters receive, record, relay, and/or supply data and digital light boxes process such data. Examples include image data but also other data such as data from anesthesia equipment. An image display apparatus that may be capable of displaying this digital data may include a data processing unit that may include a memory and a data connection. Any data processing mentioned herein may be performed by the data processing unit or may be performed externally by a separate connected apparatus.

The additional device can be or include a device for inputting data into the image display unit and/or outputting data from the image display unit. One example of such an additional device may be a device for reading-in or outputting hard-copy image material (for example, in particular a scanner and/or printer for x-ray images.

Another example of the additional device may be or include a device for scanning three-dimensional objects and for inputting the object data into the image display unit (for example, a three-dimensional scanner for medical use such as orthopedic specimens or templates).

Further, the additional device can be or include a device for triggering, controlling, or regulating a function of the image display unit (for example, a voice control device or a virtual projected switch whether hand-operated or foot-operated).

Another exemplary additional device can be or include a device for attaching or accommodating an external data processing unit (for example, a portable computer or tablet PC). The additional device may also comprise a device for monitoring the space in front of the image display unit (for example, for detecting recognition features). A suitable example of such a device may include an RFID (radio frequency identification) scanner for recognizing RFID tags on patients, medical devices, and/or instruments.

In accordance with invention, the additional device may be or include a device for visually testing the display unit (for example, for testing the display area or screen). This testing device can be a camera aimed at the display area or screen.

The additional device also may be or include a device for detecting an exterior level of illumination, either directly by measurement or indirectly by receiving data, wherein the display area can be switched to a brightly luminous mode or an emergency lighting mode when the exterior illumination fails or is insufficient. The term “exterior illumination” as used herein is intended to mean the level of illumination in the room that the system is situated (for example, the operating theater).

The additional device can include a device for detecting a user's gaze, for example, and can include a camera and software for detecting whether a user's face is facing the display.

In another example, the additional device may include a device for rotating the display unit in a plane of the display area depending on the format of the image data displayed (for example, rotating the display unit by 90°)

A device in accordance with the invention may use the central image display unit to integrate functions or maintenance tasks that are currently performed manually, using separate, additional devices, or functions and/or tasks that are not performed at all. Thus, the device may allow central intuitive access to important functions and provide the user with a consistent interface for completing a variety of tasks, thereby improving the quality assurance, energy consumption, and ergonomics.

### BRIEF DESCRIPTION OF THE DRAWINGS

The forgoing and other features of the invention are hereinafter discussed with reference to the figures.

FIG. 1 shows a display system in accordance with the invention comprising an x-ray image scanner.

FIG. 2 shows a display system in accordance with the invention comprising an x-ray image printer.

FIG. 3 shows a display system in accordance with the invention comprising a three-dimensional scanner.

FIG. 4 shows a display system in accordance with the invention comprising voice control.

FIG. 5 shows a display system in accordance with the invention comprising a camera.

FIG. 6 shows a display system in accordance with the invention functioning as emergency lighting.

FIG. 7 shows a display system in accordance with the invention comprising RFID integration.

FIG. 8 shows a display system in accordance with the invention comprising tablet PC integration.

FIG. 9 shows a display system in accordance with the invention comprising screen monitoring.

FIG. 10 shows a display system in accordance with the invention comprising automatic rotation.

FIG. 11 shows a display system in accordance with the invention comprising a projected foot-operated switch.

FIG. 12 shows a block diagram of an exemplary computer that may be used with any of the display systems described herein.

### DETAILED DESCRIPTION

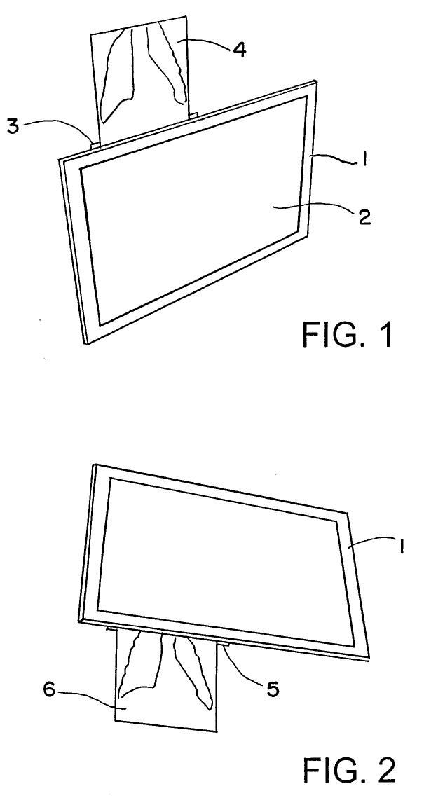

Turning to the figures, FIG. 1 shows an exemplary display system in accordance with the invention including an image display unit 1 (in this example, a digital light box) that can be operated using touch screen controls. The image display unit 1 has a display area or screen 2. The image display unit 1 can process and display digital medical images and therefore can provide visual assistance to the treatment staff before, during, and after a medical procedure.

FIG. 1 shows how an image scanner 3 (in this example, an x-ray image scanner) may be integrated with the display unit 1. The x-ray image scanner 3 enables a medical image 4 (in this example, an x-ray image film) to be scanned or digitized and displayed and/or added to the hospital's image server system. The image may be stored and retrieved by searching for a corresponding patient data set in the hospital's server system and then storing or retrieving the image. During the scanning or digitizing process, the contents of the x-ray film also can be simultaneously displayed on the screen 2, creating an impression that the film is being moved into the screen or display area 2.

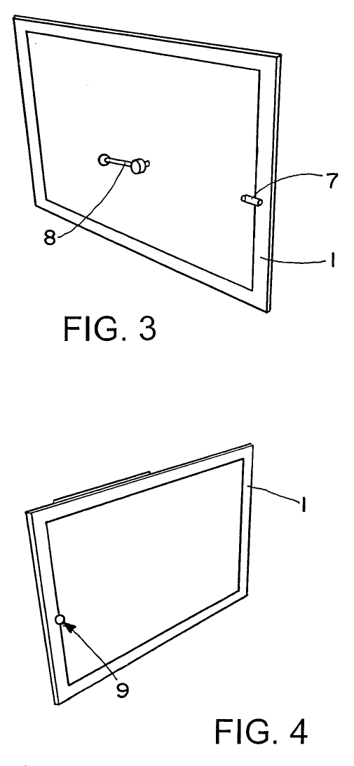

FIG. 2 shows an exemplary display system in accordance with the invention that includes an integrated printer 5 on the lower edge of the image display unit 1. Using the printer 5, a user can print any image that has been viewed on the integrated system or that is stored in the integrated system. The printed images also can be provided to the patient or, if they are x-ray images 6, they can be viewed on conventional film viewers. To print out such an x-ray film, a touch screen may be used to move an image downwards toward the printer (e.g., a drag and drop operation), which can trigger the printer to print the displayed image. The resulting print-out is printed or otherwise produced and may exit the printer 5. This process creates an impression that the digital image displayed on the screen is moved across the screen and then output as a hard copy.

FIG. 3 shows an exemplary display system in accordance with the invention in which a scanner-camera 7 is arranged on the display unit 1. The use of camera 7 allows the dimensions of objects to be determined. In this example, the object is a displayed object 8 that can be a medical or orthopedic template. U.S. Pat. No. 5,988,862, which is hereby incorporated by reference in its entirety, describes a way in which the dimensions of a three-dimensional object can be determined by scanning the object and how the object can then be incorporated into a CAD (computer aided design) program as a three-dimensional data object. In accordance with the invention, the produced three-dimensional models also can be modified and translated in relation to medical images and/or objects by being marked and manipulated on the touch screen of the image display unit once they have been scanned in.

FIG. 4 shows an exemplary display system in accordance with the invention wherein a microphone 9 is arranged on the image display unit 1. The microphone 9 allows instruction to be verbally input to the system and/or to an integrated system. Such voice-activated control enables contact-free control and manipulation of the system, thereby allowing it to be used by surgeons who are already sterilized, without the risk of becoming contaminated.

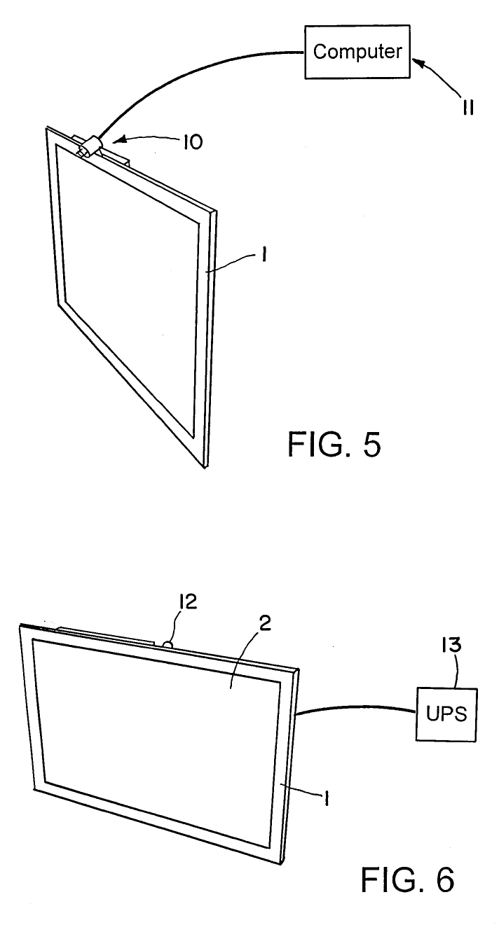

FIG. 5 shows an exemplary display system in accordance with the invention that is equipped with an integrated camera 10. In this example, camera 10 can record various image data and provide it for use with the system. One application of camera 10 is detecting a user's gaze. There are various techniques in which helmets are used to establish users' viewing angle. U.S. Pat. No. 6,433,759, which is hereby incorporated by reference in its entirety, describes a way to determine what parts of the screen a user is currently viewing.

In the example of FIG. 5, camera 10 is arranged and connected to a data processing unit or computer 11 that includes software for establishing whether any user is viewing display unit 1, wherein the camera and the computer program track all users in the vicinity of the system. If one of the users is recognized to be viewing the display unit 1 (for example, if a face is recognized from the front or laterally from the front), the illumination may be intensified, switched on from a sleeping mode, or another view may be shown that allows better viewing. This viewing optimization protocol may provide increased user-friendliness and a longer service-life for the display.

FIG. 6 shows an exemplary display system in accordance with the invention, wherein the integrated system may be used as an emergency lighting system. If a sensor 12 on the display unit 1 or elsewhere in the room establishes that the illumination is too dark, or if there is a power outage, the system can serve as emergency lighting. To this end, it can be equipped with an uninterruptible power supply (UPS) 13, and the bright display light could then allow the treatment staff in the operating theater to complete critical tasks.

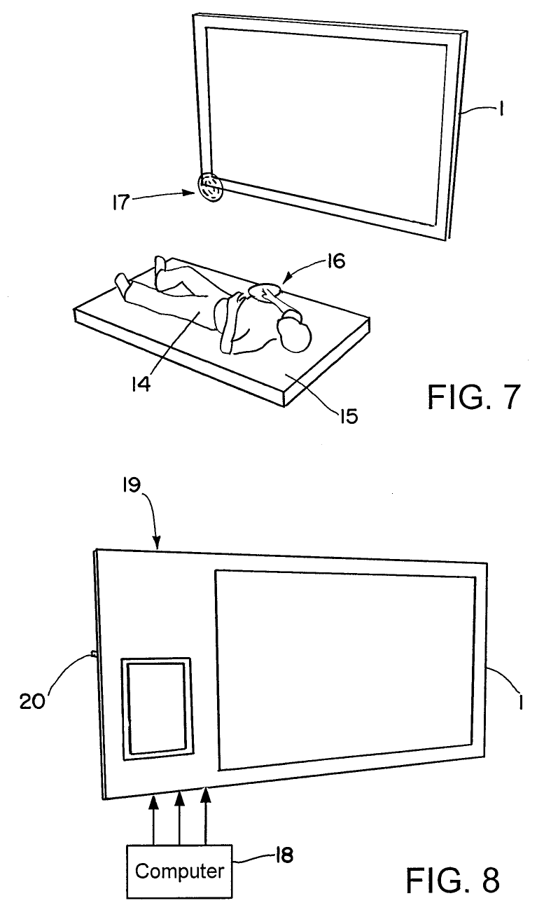

FIG. 7 shows an exemplary display system in accordance with the invention in which RFID technology is integrated with the image display unit 1. The proliferation of RFID tags in hospital environments enables patients to be equipped with RFID tags and/or transmitters. In FIG. 7, for example, a patient 14 who is lying on a table 15 has an RFID tag 16. An RFID scanner may be integrated with the display unit 1, and this RFID scanner 17 actively scans the vicinity of the system for the presence of patients (via the tags). Image data of located patients then may be automatically retrieved from the hospital's server and stored locally. Advantages of such integration include (1) verifying patient identification, (2) expediting the process for loading patient data, and (3) pre-selecting and initiating software selections corresponding to the identified patient's upcoming procedure.

FIG. 8 shows an exemplary display system in accordance with the invention in which an external data processing unit or computer 18 (in this example, a tablet PC) can be integrated with the display unit 1. In a panel region 19 of the display unit 1, an adaptor recess 20 (e.g., docking station) is provided, into which the tablet PC can be inserted. In this example, the integrated system may comprise a number of image display monitors, and the tablet PC 18 with its touch screen monitor can provide control functions for the image display. When the tablet PC 18 is attached to the system, its touch screen monitor can function as an integral part of the system. The tablet PC 18, however, also can be removed from the unit 1 and used as a freestanding unit. If the image data and/or other data are synchronized, any image data stored on the tablet PC can be inspected and/or manipulated at a remote location.

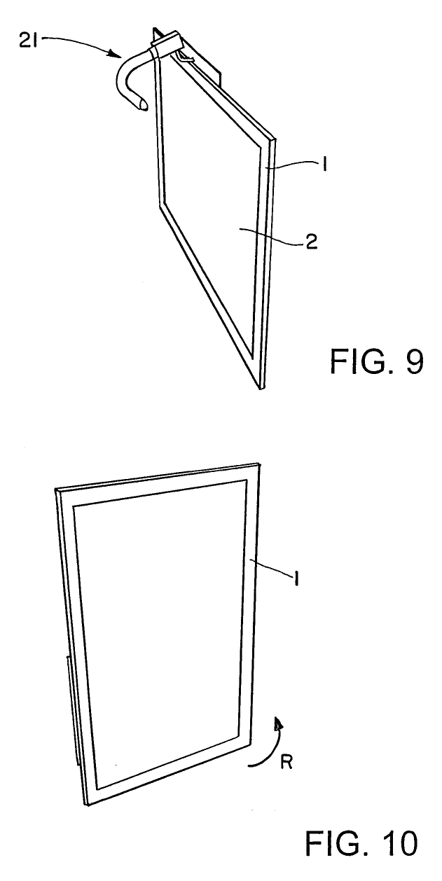

FIG. 9 shows an exemplary display system in accordance with the invention wherein a camera and a movable, extended lens or light sensor are integrated with the image display unit 1. One problem with touch screen monitor systems can be that fingerprints on the surface of the screen can distort the image output. The embodiment in FIG. 9 allows automatic quality control for the display, wherein the camera 21 records camera images of the display 2. The camera images can be compared with the image data provided to the display, and if there are differences, these are ascribed to prints or other image distortions or to monitor defects (pixel errors). The displays can be mechanically cleaned, for example, as is described in U.S. Pat. No. 6,934,590, which is hereby incorporated by reference in its entirety, or the integrated system can request maintenance or indicate that cleaning is required.

FIG. 10 shows an exemplary display system in accordance with the invention wherein the image display unit 1 is rotatable (see arrow R). The image display unit 1 may be rotated in the plane of the display by a known rotating device, wherein the rotating device can include motors and hinges (not shown). Monitors are generally rectangular and generally have aspect ratios of 4:3 or 16:9. Some monitors can be rotated by 90° and, when rotated, automatically change their display. Such functionality can be integrated in reverse in the example display system. CT scans in most cases, comprise a number of sectional image views that are displayed in landscape format. The display system in accordance with the invention may rotate the monitor into the landscape format direction when such images are called for display. Conversely, the system may rotate the display unit 1 into the portrait format when images are called for display that are more easily viewed in this representation (for example, x-ray images of spinal columns).

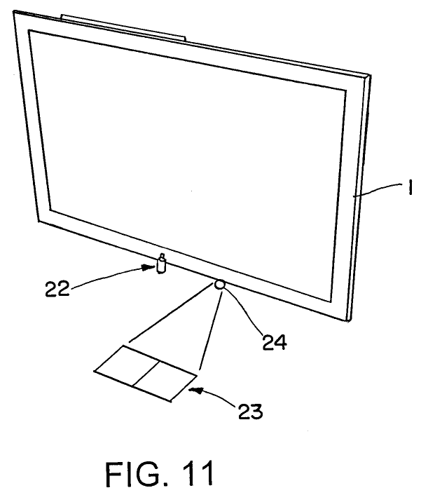

FIG. 11 shows an exemplary display system in accordance with the invention wherein the image display unit 1 may comprise a projection device 22 that projects, for example, a virtual pedal 23 onto the floor. The main user interface in the integrated system may be the multi-touch screen of the display device 1. For some actions (for example, changing to the next or previous sectional image) it is helpful to provide “shortcuts,” the use of which do not require the user to approach the system or screen. Foot pedals are used in a number of medical devices. In accordance with the invention, the projector or light emitter 22 will illuminate a particular location on the floor with virtual pedal 23, thus virtually providing one or more foot-operated switches. Each pedal can be labeled in accordance with the concurrently executed software application and its function, and an optical sensor 24 detects whether the user is activating/stepping on one of the virtual foot-operated switches. If the switch is activated (e.g., the user steps on the virtual pedal), the optical sensor 24 can send an activation signal to the software application currently in use.

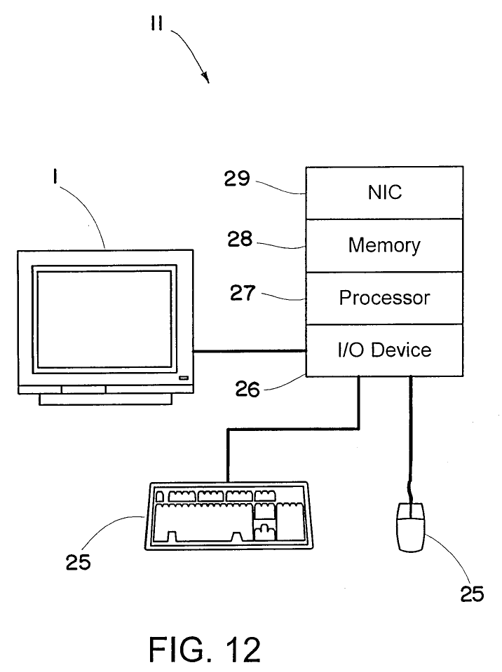

Turning now to FIG. 12 there is shown a block diagram of an exemplary computer 11 that may be used in connection with any of the display systems described herein. The computer 11 may be a standalone computer, or it may be part of the image display system, for example (e.g., integrated within the image display unit 1). The computer 11 may be connected to a display unit 1 for viewing system information, and an input device 25 for data entry, screen navigation, etc. Examples of an input device 25 include a keyboard, computer mouse or other device that points to or otherwise identifies a location, action, etc., e.g., by a point and click method or some other method. Alternatively, a touch screen (shown in FIG. 6 as reference no. 2) may be used in place of the input device 25. The monitor 1 and input device 25 communicate with a processor via an input/output device 26, such as a video card and/or serial port (e.g., a USB port or the like).

A processor 27 combined with a memory 28 execute programs to perform various functions, such as data entry, numerical calculations, screen display, system setup, etc. The memory 28 may comprise several devices, including volatile and non-volatile memory components. Accordingly, the memory 28 may include, for example, random access memory (RAM), read-only memory (ROM), hard disks, floppy disks, optical disks (e.g., CDs and DVDs), tapes, flash devices and/or other memory components, plus associated drives, players and/or readers for the memory devices. The processor 27 and the memory 28 are coupled using a local interface (not shown). The local interface may be, for example, a data bus with accompanying control bus, a network, or other subsystem.

The memory may form part of a storage medium for storing information, such as application data, screen information, programs, etc., part of which may be in the form of a database. The storage medium may be a hard drive, for example, or any other storage means that can retain data, including other magnetic and/or optical storage devices. A network interface card (NIC) 29 allows the computer 11 to communicate with other devices. Such other devices may include a camera 10 (as shown in FIG. 5).

Although the invention has been shown and described with respect to a certain preferred embodiment or embodiments, it is obvious that equivalent alterations and modifications will occur to others skilled in the art upon the reading and understanding of this specification and the annexed figures. For example, regard to the various functions performed by the above described elements (components, assemblies, devices, software, computer programs, etc.), the terms (including a reference to a “means”) used to describe such elements are intended to correspond, unless otherwise indicated, to any element that performs the specified function of the described element (i.e., that is functionally equivalent), even though not structurally equivalent to the disclosed structure that performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A medical display system for performing a medical function, comprising:
an image display unit configured for displaying a medical image data set, and
an additional device,
wherein said additional device is integrated with said image display unit and is configured to assist in performing the medical function of the medical display system.

2. The medical display system according to claim 1, further comprising:
a data processing unit integrated with the image display unit,
an adaptor secured to the image display unit that is
configured for attaching the additional device to the image display unit, and/or
configured for exchanging data between the data processing unit and the additional device.

3. The medical display system according to claim 1, wherein the additional device is configured for transferring data into and/or out of the image display unit.

4. The medical display system according to claim 1, wherein the additional device comprises a device for scanning and/or printing hard-copy image material.

5. The medical display system according to claim 4, wherein the additional device comprises an x-ray image scanner or printer.

6. The medical display system according to claim 1, wherein the additional device comprises a device for scanning a three-dimensional object(s) to produce object data set(s) and for transferring the produced object data set(s) into the image display unit.

7. The medical display system according to claim 6, wherein the additional device comprises a three-dimensional scanner configured to scan orthopedic specimens or templates.

8. The medical display system according to claim 1, wherein the additional device comprises a device for triggering, controlling, and/or regulating a function of the image display unit.

9. The medical display system according to claim 8, wherein the function of the image display unit comprises voice control or a virtual, projected switch that may operated by hand or by foot.

10. The medical display system according to claim 1, wherein the additional device comprises a device for attaching, accommodating, securing, and/or adapting an external data processing unit for integrated use with the image display unit

11. The medical display system according to claim 10, wherein the external processing unit comprises a portable computer or a tablet PC.

12. The medical display system according to claim 1, wherein the additional device comprises a device configured to monitor a space in front of the image display unit and recognize features in said space.

13. The medical display system according to claim 12, wherein, the additional device comprises an RFID scanner configured to recognize RFID tags on patients, medical devices, and/or instruments.

14. The medical display system according to claim 1, wherein the additional device comprises a device configured to optically test a display area or screen of the image display unit.

15. The medical display system according to claim 14, wherein the additional device comprises a camera configured to be aimed at the display area or screen.

16. The medical display system according to claim 1, wherein the additional device comprises a device configured to detect an ambient level of illumination in an area proximate to the image display unit directly by measurement or indirectly by receiving data.

17. The medical display system according to claim 16,
wherein the image display unit comprises a display area, and
wherein the image display unit is adapted to switch the display area to a brightly luminous mode or emergency lighting mode when the device configured to detect an ambient level of illumination provides an indication to the image display unit that the ambient level of illumination is below a predetermined level.

18. The medical display system according to claim 1, wherein the additional device comprises a device configured to detect a user's gaze.

19. The medical display system according to claim 18, wherein the device configured to detect a user's gaze comprises a camera and software configured to detect whether a user is facing the image display unit.

20. The medical display system according to claim 1, wherein the image display unit comprises a planar display area, and the additional device comprises a device configured to rotate the image display unit in the plane of the display area, in response to an indication of an orientation of the image data set to be displayed.

21. The medical display system according to claim 20, wherein the device configured to rotate the image display unit is further configured to rotate the image display unit from a landscape to a portrait orientation and vice versa.

22. The medical display system according to claim 1, wherein the image display unit comprises a digital light box.
